(19) United States
(12) Patent Application Publication
(10) Pub. No.: US 2009/0283369 A1
(43) Pub. Date: Nov. 19, 2009

(54) Communication of Service Disruption Information in a Group Elevator System

(76) Inventors: Michael P. Flynn, Avon, CT (US); Anne R. Davis, Middlefield, CT (US); Paul A. Simcik, Bristol, CT (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/988,786

(22) PCT Filed: Jul. 18, 2005
(86) PCT No.: PCT/US05/25255

§ 371 Date: Feb. 16, 2009

(51) Int. Cl. B66B 3/00

(52) U.S. Cl. 187/391

(57) ABSTRACT

Elevator service disruption information is communicated to passengers in a group elevator system (10). The group elevator system (10) includes a group of elevators (14a, 14b, 14c) operable to transport each of the passengers to one of a plurality of floors (L, F2, F3, F4, F5). A destination entry input device (30, 35) at each floor permits each passenger to enter destination input information. A dispatch controller (20) controls dispatching of the elevators (14a, 14b, 14c) based on the destination input information and determines when elevator service is disrupted. A communication device (30, 35), which is responsive to information from the dispatch controller (20) when elevator service is disrupted, provides to passengers at each floor notice of the service disruption and response instructions related to the elevator service disruption.

### BACKGROUND OF THE INVENTION

The present invention relates to the field of elevator control, and in particular to communicating service disruption information to passengers in a group elevator system.

Conventional group elevator systems include up and down buttons near the elevators for use by passengers when elevator service is desired. When a disruption in elevator service occurs in a conventional group elevator system, there is no efficient way to communicate information about the service disruption. In particular, conventional elevator systems do not include audio or visual capabilities to communicate this information. As a result, passengers may become confused about how best to find an alternative route to their desired destination. In addition, passengers may become concerned about the cause of the elevator service disruption, such as whether the elevator service disruption is the result of an emergency situation. This inability to quickly communicate information regarding elevator service disruption can have serious ramifications, especially in situations requiring building evacuation.

Recently, elevator systems with destination entry have been introduced. In a destination entry system, passengers are required to register their destination floors in the hallway prior to entering the assigned elevator. Passengers register their destination floors on destination entry devices, which are mounted near the elevators and often take the form of a numeric keypad or a touch screen display. The destination entry devices often include audio and visual capabilities, for example to verify a passenger's destination floor entry and to assist passengers with disabilities.

### BRIEF SUMMARY OF THE INVENTION

The subject invention is directed to communicating elevator service disruption information to passengers in a group elevator system. The group elevator system includes multiple elevators operable to transport each of the passengers to one of a plurality of floors. A destination entry input device at each floor permits each passenger to enter destination input information. A dispatch controller controls dispatching of the elevators based on the destination input information and determines when elevator service is disrupted. A communication device, which is responsive to information from the dispatch controller when elevator service is disrupted, provides to passengers at each floor notice of the service disruption and response instructions related to the elevator service disruption.

### BRIEF DESCRIPTION OF THE DRAWINGS

FIG. 1 is a perspective view of a destination entry group elevator system.

FIG. 2 is a perspective view of a keypad used in the destination entry group elevator system shown in FIG. 1.

FIG. 3 is a perspective view of a touch screen display used in the destination entry group elevator system shown in FIG. 1.

FIG. 4 is a flowchart for the process of communicating elevator service disruption information to passengers according to the present invention.

### DETAILED DESCRIPTION

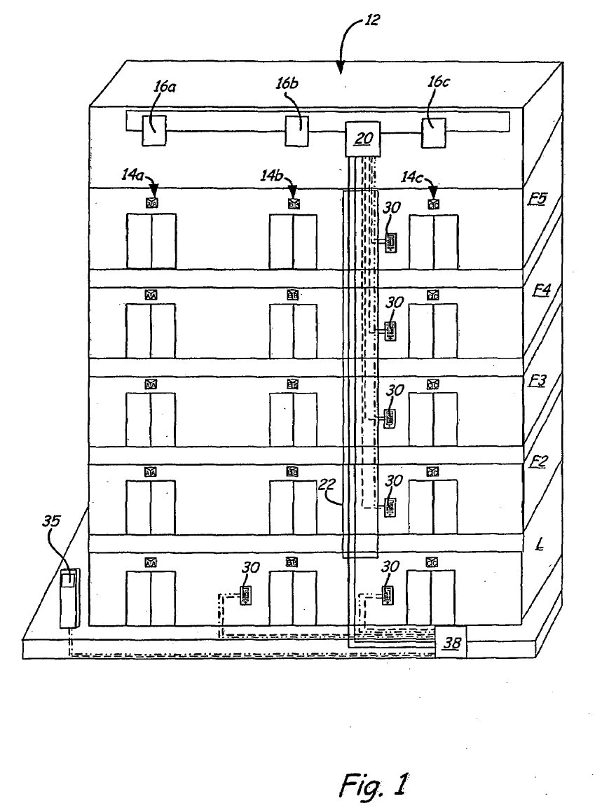

FIG. 1 is a perspective view of destination entry based elevator system 10 in building 12. Building 12 includes five floors, including lobby floor L, second floor F2, third floor F3, fourth floor F4, and fifth floor F5. Group elevator system 10 includes three elevators 14a, 14b, and 14c, each of which is operable to transport passengers to any of the floors in building 12. While three elevators 14a-14c and five floors L and F2-F5 are shown, it will be appreciated that the present invention is applicable to destination entry group elevator systems with any number of elevators servicing any number of floors.

The operation of each elevator is controlled by a dedicated car controller. In particular, elevator 14a is controlled by car controller 16a, elevator 14b is controlled by car controller 16b, and elevator 14c is controlled by car controller 16c. Car controllers 16a-16c are connected to and communicate with each other via communications loop 18.

Car controllers 16a-16c control elevators 14a-14c, respectively, based on elevator control information received from destination entry controller (DEC) 20. DEC 20 is connected to car controllers 16a-16c via communications loop 18. DEC 20 processes destination input information received via communications lines 22 and provides elevator control information based on the destination input information.

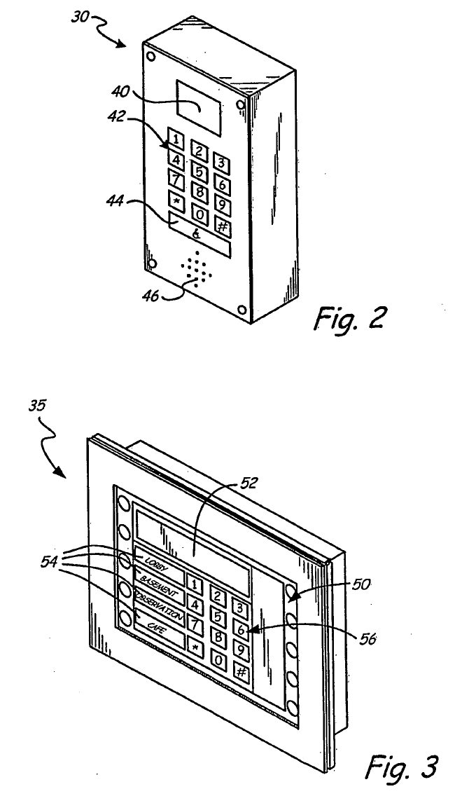

Destination input information is provided by passengers via destination entry input devices located on each floor. The destination entry input devices are located next to the elevators on each floor and are used by passengers to enter their desired destination floor via numbered keys on the input device. The destination entry input devices may also include keys labeled for specific areas of the building such that a passenger may press the labeled keys to be transported directly to the area on the key. In group elevator system 10, the destination entry input devices include keypads 30 and touch screen display 35. Keypads 30 will be described in more detail with regard to FIG. 2, and touch screen display 35 will be described in more detail with regard to FIG. 3. Each keypad 30 on floors F2-F5 is connected directly to DEC 20 via a data line (e.g., Ethernet) and a common ground line. Keypads 30 and touch screen display 35 on lobby floor L are connected to DEC 20 via pit controller 38. It will be appreciated that any combination of keypads 30 and touch screen displays 35 may be employed throughout building 12. Alternatively, keypads 30 on floors L-F5 may be replaced by conventional up and down hall call buttons.

The scheduling of elevators 14a-14c is coordinated by DEC 20 based on the destination input information provided on keypads 30 and touch screen display 35. Elevators 14a-14c are independent, but are coupled through serving a common pool of passengers. For each passenger, there is only one elevator 14 that will serve that passenger. As each passenger enters his or her destination floor on one of keypads 30 or touch screen display 35, the passenger is directed to an elevator that will most efficiently service his or her destination request. DEC 20 groups passengers who are going to common or nearby floors to the same elevator 14. DEC 20 communicates with car controllers 16a-16c to determine the locations of elevators 14a-14c when assigning passengers to an elevator. When passengers enter their assigned elevator, the car controller controls the elevator so as to stop only at those floors that passengers on the assigned elevator requested. By grouping passengers in this way, passengers reach their destination floor in an efficient manner with fewer stops than in conventional elevator systems.

FIG. 2 is a perspective view of keypad 30 used in the destination entry group elevator system 10 shown in FIG. 1. Keypad 30 includes display 40, numeric keys 42, accessibility key 44, and electroacoustic transducer or speaker 46. In one embodiment, display 40 is a liquid crystal display (LCD) or light-emitting diode (LED) type display.

When a passenger wishes to be transported between floors in group elevator system 10, the passenger enters his or her desired destination floor using numeric keys 42. For example, if a passenger wants to be transported from lobby floor L to floor F4, the passenger presses the “4” key on numeric keys 42 of one of keypads 30 located on lobby floor L. This destination input information is then provided to DEC 20. Based on the locations of the cars in elevators 14a-14c (as provided by car controllers 16a-16c), DEC 20 provides a signal to keypad 30 that was used by the passenger to enter the destination input information. This signal contains the passenger's elevator assignment. Keypad 30 then directs the passenger to the appropriate elevator using display 40. For example, if the passenger uses keypad 30 nearest elevator 14c to enter the destination input information, and the passenger is assigned to elevator 14a by DEC 20, the letter “A” appears on display 40. An arrow or other directing symbol may also be displayed on display 40 to guide the passenger in the direction of the assigned elevator.

Keypad 30 also includes accessibility key 44 for use by disabled passengers to initiate service in group elevator system 10. When a passenger presses accessibility key 44, auditory instructions regarding use of keypad 30 are provided on speaker 46. For example, the passenger may be directed to use numeric keys 42 to enter his or her desired destination floor. After the passenger enters his or her desired destination floor, the passenger is given auditory directions via speaker 46 regarding which elevator is assigned to the passenger and how to reach the assigned elevator. The assigned elevator may also be simultaneously displayed on display 40 as described above.

FIG. 3 is a perspective view of a touch screen display 35 used in the destination entry group elevator system 10 shown in FIG. 1. Touch screen display 35 includes screen 50 for displaying various interactive buttons for use by passengers to operate group elevator system 10. The information provided on screen 50 is customizable to the building in which it is provided. In the embodiment shown, screen 50 includes active display 52, location specific buttons 54, and numeric keys 56.

When a passenger wishes to be transported between floors in group elevator system 10, the passenger enters his or her desired destination floor using numeric keys 56. For example, if a passenger wants to be transported from lobby floor L to floor F4, the passenger presses the “4” key on numeric keys 56 of touch screen 35 located on lobby floor L. This destination input information is then provided to DEC 20. Based on the locations of the cars in elevators 14a-14c (as provided by car controllers 16a-16c), DEC 20 provides a signal to touch screen 35. This signal contains the passenger's elevator assignment. Touch screen 35 then directs the passenger to the appropriate elevator using active display 52. For example, if the passenger is assigned to elevator 14a by DEC 20, the letter “A” appears on active display 52. An arrow or other directing symbol may also be displayed on active display 52 to guide the passenger in the direction of the assigned elevator.

Additionally, screen 50 includes location-specific buttons 54. These buttons are optionally provided on screen 50 to allow passengers to select their destination based on a particular location or featured area of the building. For example, in a system including a touch screen display 35 on each floor, a passenger on floor F3 desiring to go to lobby level L could press the button labeled “LOBBY” on screen 50 (instead of pressing the “1” key for the first level). The passenger would then be directed via active display 52 to the elevator that will most efficiently transport him or her to lobby level L.

When a disruption in group elevator service occurs, passengers are made aware of the reason for the disruption to avoid causing confusion and alarm in the passengers. For example, service disruption may be caused by emergency situations, such as by natural disasters, fire, or the need to shut down group elevator system 10 for emergency use only. Also, service disruption may be caused by non-emergency situations, such as power failure, elevator servicing, or electrical or mechanical failure of the elevator system. In addition to alerting passengers to the cause of elevator service disruption, passengers are instructed as to how to either reach their desired destination using alternative routes or evacuate the building in an efficient manner.

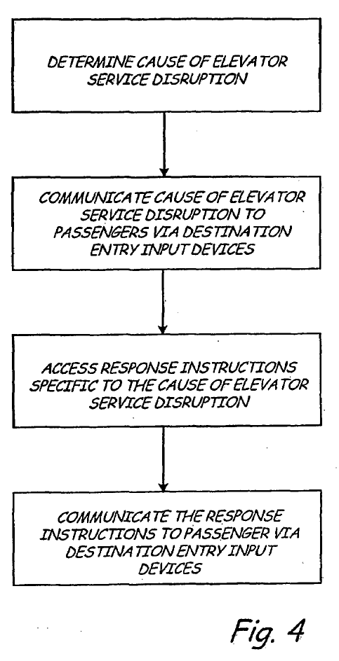

FIG. 4 is a flow chart for the process of communicating elevator service disruption information to passengers in group elevator system 10 according to the present invention. When a service disruption occurs, the elevator system first determines the cause of the service disruption (step 60). In one embodiment, DEC 20 determines the cause of the elevator service disruption. For example, if a fire alarm in building 12 is activated, DEC 20 receives a signal indicating that group elevator system 10 has shifted to fire service operation.

When the cause of the group elevator service disruption has been determined, information regarding the cause of the elevator service disruption is communicated to the passengers (step 62). This information is communicated to the passengers in auditory format via speaker 46 on keypads 30. For example, a voice explanation of the cause of the elevator service disruption may be provided via speaker 46. This audible information may be provided only to keypads 30 on which passengers enter or have entered destination input information. Alternatively, the audible information may be provided at all keypads 30 throughout building 12 on a continuous loop.

In addition to the auditory communication of the cause of elevator service disruption information on keypads 30, touch screen display 35 may be used to visually communicate elevator service disruption information to passengers. For example, location-specific buttons 54 and numeric keys 56 may be removed from screen 50 and replaced with a textual or graphical explanation of the cause of the elevator service disruption.

After the cause of the elevator service disruption has been determined and communicated to the passenger, response instructions specific to the cause of the elevator service disruption are then accessed (step 64). In one embodiment, the response instructions are stored in a database in DEC 20. The response instructions provide details to passengers regarding how to most efficiently reach their desired destination (e.g., the nearest stairwell). If the disruption in elevator service will be brief, the response instructions may also provide information regarding the anticipated length of disruption. In the case of an emergency situation requiring evacuation, the response instructions may be directed to how to most efficiently evacuate building 12 by guiding the passengers to the nearest building exit.

The response instructions are subsequently communicated to passengers via the destination entry input devices of group elevator system 10 (step 66). In particular, the response instructions are communicated to the passengers in auditory format via speaker 46 on keypads 30. For example, a voice explanation of the most direct route to a passenger's desired destination may be provided on speaker 46 when the passenger enters his or her desired destination on keypad 30. In the case of an emergency requiring evacuation, the response instructions may be continuously repeated on speaker 46 to assure that all occupants of building 12 hear the evacuation procedures. This facilitates quick and efficient evacuation of building 12.

In addition to the auditory communication of the response instructions information via speaker 46 of keypad 30, touch screen display 35 may be used to visually communicate elevator service disruption information to passengers. Location-specific buttons 54 and numeric keys 56 may be removed from screen 50 and replaced with a textual or graphical explanation of the response instructions. For example, a graphic showing the location alternative routes (e.g., the nearest stairwell) to the passenger's desired destination may be displayed on screen 50 in place of the standard user interface. The information provided on screen 50 may also be animated to further assist passengers in responding to the elevator service disruption. The graphical description of the response instructions is useful in emergency situations requiring evacuation to facilitate quick and efficient evacuation of building 12.

In summary, conventional group elevator systems do not include audio or visual capabilities to communicate elevator service disruption information to passengers. As a result, passengers may become confused about how best to find an alternative route to their desired destination or concerned about the cause of the elevator service disruption. The present invention is directed to communicating elevator service disruption information to passengers in a group elevator system. The group elevator system includes a group of elevators that is operable to transport each of the passengers to one of a plurality of floors. A destination entry input device at each floor permits each passenger to enter destination input information. A dispatch controller controls dispatching of the elevators based on the destination input information and determines when elevator service is disrupted. A communication device, which is responsive to information from the dispatch controller when elevator service is disrupted, provides to passengers at each floor notice of the service disruption and response instructions related to the elevator service disruption.

Although the present invention has been described with reference to examples and preferred embodiments, workers skilled in the art will recognize that changes may be made in form and detail without departing from the spirit and scope of the invention.

1. A system comprising:
a group of elevators operable to transport each of a plurality of passengers to one of a plurality of floors;
a destination entry input device at each floor for permitting each passenger to enter destination input information;
a dispatch controller for controlling dispatching of the elevators based on the destination input information and for determining when elevator service is disrupted; and
a communication device responsive to information from the dispatch controller when elevator service is disrupted which provides to passengers at each floor notice of the service disruption and response instructions related to the elevator service disruption.

2. The system of claim 1, wherein the destination entry input device comprises a keypad.

3. The system of claim 1, wherein the destination entry input device comprises a touch screen display.

4. The system of claim 1, wherein the communication device comprises an electroacoustic transducer.

5. The system of claim 1, wherein the communication device comprises an electronic display.

6. The system of claim 1, wherein the destination entry input device and the communication device are provided in a combined form.

7. The system of claim 1, wherein the notice of the service disruption and response instructions are communicated to floors on which a passenger provided destination input information on a destination entry input device.

8. The system of claim 1, wherein the notice of the service disruption and response instructions are communicated to all floors.

9. A method for communicating with passengers in a group elevator system, the method comprising:
controlling operation of elevators of the group elevator system; determining a condition resulting in disruption of normal operation of the elevators;
informing the passengers of a reason for the elevator service disruption; and
providing response instructions to the passengers based on the reason for the elevator service disruption.

10. The method of claim 9, wherein controlling operation of the elevators of the group elevator system comprises:
receiving destination input information from each passenger on a destination entry input device; and
controlling dispatching of the elevators based on the destination input information.

11. The method of claim 9, wherein informing the passengers of a reason for the elevator service disruption comprises providing an auditory description of the cause of the service disruption.

12. The method of claim 9, wherein informing the passengers of a reason for the elevator service disruption comprises providing a visual description of the cause of the service disruption.

13. The method of claim 9, wherein providing response instructions to the passengers comprises:
accessing response instructions specific to the cause of the elevator service disruption from a stored database; and
conveying the response instructions to the passengers.

14. The method of claim 13, wherein conveying the response instructions to the passengers comprises audibly communicating the response instructions to the passengers.

15. The method of claim 13, wherein conveying the response instructions to the passengers comprises visually communicating the response instructions to the passengers.

16. A method for alerting passengers to an elevator service disruption in a group elevator system, the method comprising:
determining a reason for the elevator service disruption; communicating the reason for the elevator service disruption to the passengers;
accessing response instructions specific to the reason for the elevator service disruption from a stored database; and
communicating the response instructions to the passengers.

17. The method of claim 16, wherein communicating the reason for the elevator service disruption to the passengers comprises providing an auditory explanation of the cause of the service disruption.

18. The method of claim 16, wherein communicating the reason for the elevator service disruption to the passengers comprises providing a visual explanation of the cause of the service disruption.

19. The method of claim 16, wherein communicating the response instructions to the passengers comprises audibly communicating the response instructions to the passengers.

20. The method of claim 16, wherein communicating the response instructions to the passengers comprises visually communicating the response instructions to the passengers.
